(19) United States
(12) Patent Application Publication
(10) Pub. No.: US 2026/0238074 A1
(43) Pub. Date: Aug. 13, 2026

(54) ELECTRICAL CONNECTION COMPONENT AND ELECTRICAL CONNECTION UNIT

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yasuhiro KUDO, Mie (JP); Daisuke HASHIMOTO, Mie (JP); Kentaro TACHI, Mie (JP); Yoshitomo TSUJII, Mie (JP)

(21) Appl. No.: 19/470,818

(22) PCT Filed: Mar. 14, 2024
(86) PCT No.: PCT/JP2024/010086

§ 371 Date: Sep. 30, 2025

(30) Foreign Application Priority Data
Apr. 3, 2023 (JP) 2023-060219

(51) Int. Cl. H02K 5/22; H01R 9/18; H01R 9/22

(52) U.S. Cl. CPC H02K 5/225; H01R 9/18; H01R 9/223; H01R 2201/10

(57) ABSTRACT

An electrical connection component (3) comprises wiring (2), an insulation part (8) that is integrally provided to the wiring (2) and that insulates the wiring (2), and a metal plate part (14). The plate part (14) is integrally provided to the insulation part (8) and is fixed to a housing (4) of an attachment target by a fastening part (15). The plate part (14) has at least one mounting part (20) that is formed by drawing and that is for installing the fastening part (15). The mounting part (20) has a hole (22) into which is inserted a shaft part (21) of the fastening part (15), and a protruding wall (23) which protrudes toward the housing (4) from the periphery of the hole (22).

### TECHNICAL FIELD

The present disclosure relates to an electrical connection component and an electrical connection unit.

### BACKGROUND

Conventionally, a terminal block for rotating electric machine including a power connector, a signal connector and a base integrated with a plate by resin insert molding is known as disclosed in Patent Document 1. The plate is made of metal and used to fix the terminal block for rotating electric machine to a case. The plate includes a plurality of fixing holes for fixing the base to the case. The terminal block for rotating electric machine is fixed to the case by a plurality of screws having shaft portions passed through the fixing holes of the plate.

### PRIOR ART DOCUMENT

### Patent Document

Patent Document 1: JP 2011-177002 A.

### SUMMARY OF THE INVENTION

### Problems to be Solved

In the case of the terminal block disclosed in Patent Document, the plate is in the form of a flat plate and the base has a predetermined thickness. Thus, the base includes a step projecting from the plate by a predetermined amount on a surface facing the case in the terminal block for rotating electric machine. Accordingly, the surface of the case facing the plate needs to be formed higher by the predetermined amount, wherefore the surface of the case needs to be processed. Therefore, there has been a concern for an increase in processing time and effort and a manufacturing cost increase.

The present disclosure aims to provide an electrical connection component and an electrical connection unit enabling the surface processing of an enclosure to be simplified.

### Means to Solve the Problem

An electrical connection component for solving the above problem is provided with a wiring, an insulating portion integrally provided to the wiring, the insulating portion insulating the wiring, and a plate portion made of metal, the plate portion being integrally provided to the insulating portion, the plate portion being fixed to an enclosure as a mounting destination by a fastening portion, the plate portion including at least one mounting portion formed by a drawing process to mount the fastening portion, and the mounting portion including a hole, a shaft portion of the fastening portion being inserted through the hole, and a projecting wall projecting toward the enclosure from a peripheral edge of the hole.

### Effect of the Invention

The present disclosure can simplify the surface processing of an enclosure.

### BRIEF DESCRIPTION OF THE DRAWINGS

FIG. 1 is a perspective view of an electrical connection unit.

FIG. 2 is a perspective view of an electrical connection component when viewed from a back side.

FIG. 3 is an exploded perspective view of the electrical connection unit.

FIG. 4 is a section along IV-IV shown in FIG. 1.

FIG. 5 is a section showing a height of a projecting wall.

FIG. 6 is a perspective view showing an annular pattern of a drawing process.

FIGS. 7A to 7D are diagrams showing a procedure of the drawing process.

### DETAILED DESCRIPTION TO EXECUTE THE INVENTION

First, embodiments of the present disclosure are listed and described.

[1] The electrical connection component of the present disclosure is provided with a wiring, an insulating portion integrally provided to the wiring, the insulating portion insulating the wiring, and a plate portion made of metal, the plate portion being integrally provided to the insulating portion, the plate portion being fixed to an enclosure as a mounting destination by a fastening portion, the plate portion including at least one mounting portion formed by a drawing process to mount the fastening portion, and the mounting portion including a hole, a shaft portion of the fastening portion being inserted through the hole, and a projecting wall projecting toward the enclosure from a peripheral edge of the hole.

According to this configuration, the insulating portion including the wiring is provided with the plate portion made of metal for mounting the electrical connection component on the enclosure. The plate portion is formed with the mounting portion by the drawing process. The electrical connection component is fixed to the enclosure by mounting the fastening portion into the mounting portion and fastening the fastening portion to the enclosure. Particularly, in the case of this configuration, the mounting portion has a projecting shape including the projecting wall. Thus, the plate portion is shaped to reach a surface of the enclosure, wherefore the surface of the enclosure can be used in a flat state. Therefore, the surface processing of the enclosure can be simplified.

[2] In [1] described above, the mounting portions are provided on both sides of the plate portion. According to this configuration, the electrical connection component can be firmly fixed to the enclosure on the both sides of the plate portion.

[3] In [1] or [2] described above, a height of the projecting wall is set to a value corresponding to a sealing member for sealing between the enclosure and the insulating portion and a seal supporting portion provided on the insulating portion to support the sealing member. According to this configuration, the height of the projecting wall can be so set that the sealing member has a sufficient sealing pressure.

[4] In any one of [1] to [3] described above, an inner peripheral surface of the hole is formed into a smooth shape without any screw threads. According to this configuration, the shape of the mounting portion can be simplified.

[5] In any one of [1] to [4] described above, the fastening portion fixes the plate portion to the enclosure by fastening the shaft portion to a fastened portion recessed in the enclosure while bringing a head portion into contact with an upper surface of the mounting portion. According to this configuration, the plate portion can be firmly fixed to the enclosure, using the fastening portion such as a bolt or a screw.

[6] In any one of [1] to [5] described above, the plate portion is integrally formed to the insulating portion by insert molding. According to this configuration, the wiring, the insulating portion and the plate portion are formed as an integrated assembly, therefore contributing to ease of component handling and ease of fixing to the enclosure.

[7] In any one of [1] to [6] described above, the mounting portion has an annular pattern in a plurality of layers having different diameters around the hole. According to this configuration, the mounting portion can be formed by the drawing process.

[8] An electrical connection unit of the present disclosure is provided with an electrical connection component including a wiring, an insulating portion integrally provided to the wiring, the insulating portion insulating the wiring, and a plate portion made of metal, the plate portion being integrally provided to the insulating portion, the plate portion being fixed to an enclosure as a mounting destination by a fastening portion, and the enclosure as the mounting destination of the electrical connection component, the plate portion including at least one mounting portion formed by a drawing process to mount the fastening portion, and the mounting portion including a hole, a shaft portion of the fastening portion being inserted through the hole, and a projecting wall projecting toward the enclosure from a peripheral edge of the hole. According to this configuration, functions and effects similar to those of the electrical connection component are obtained.

### Details of Embodiment of Present Disclosure

A specific example of the present disclosure is described below with reference to the drawings. Note that the present invention is not limited to these illustrations, but is represented by claims and intended to include all changes in the scope of claims and in the meaning and scope of equivalents. For the convenience of description, some components may be shown in an exaggerated or simplified manner in each drawing. Further, a dimension ratio of each part may be different from an actual one.

### (Electrical Connection Unit 1)

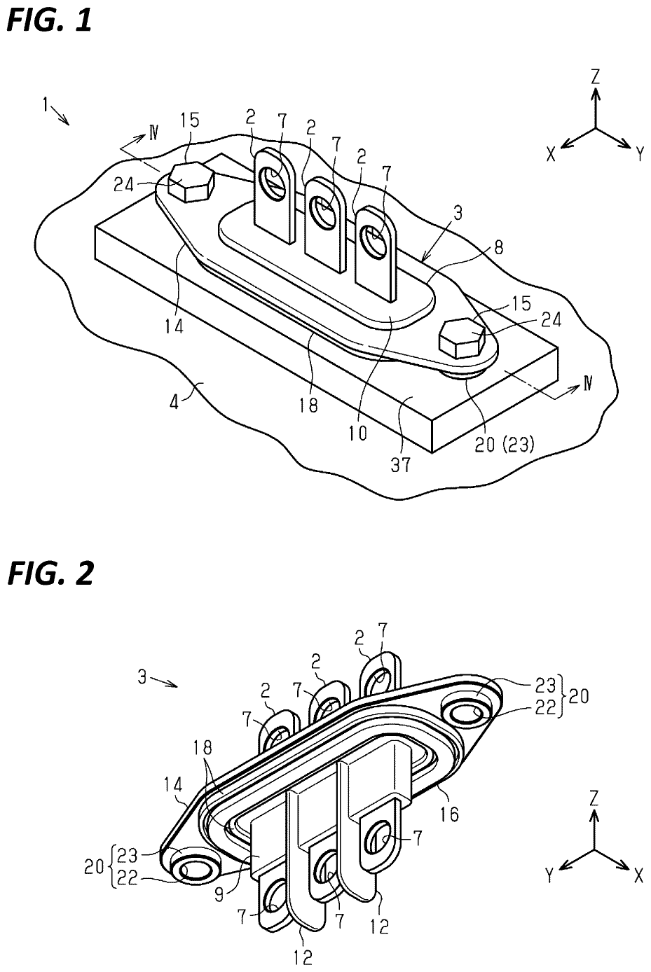

As shown in FIG. 1, an electrical connection unit 1 is provided with an electrical connection component 3 including wirings 2 and an enclosure 4 as a mounting destination of the electrical connection component 3. The electrical connection component 3 is, for example, a terminal block for fixing and mounting mating wirings (not shown) to the wirings 2 by bolts or the like. The wiring 2 is, for example, a bar-like conductor, i.e. a so-called busbar, in which a large current flows. The electrical connection unit 1 is, for example, a terminal block unit.

### (Electrical Connection Component 3)

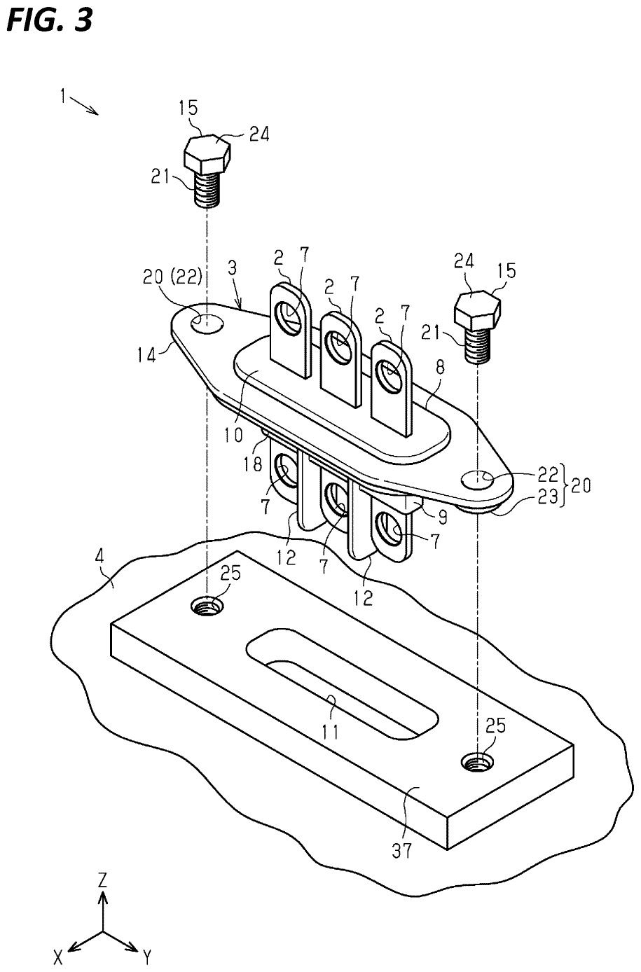

As shown in FIGS. 2 and 3, a plurality of the wirings 2 are provided side by side in a width direction of the electrical connection component 3 (Y-axis direction in FIG. 2 and the like). In the case of this example, the plurality of wirings 2 are arranged at equal intervals in the width direction of the electrical connection component 3 (Y-axis direction of FIG. 2 and the like). The wiring 2 is, for example, a busbar made of metal. Insertion holes 7, through which members such as bolts for fixing the mating wirings (not shown) are inserted, are formed in both ends of the wiring 2.

For example, the electrical connection component 3 electrically connects a motor (not shown) installed inside the enclosure 4 and an external inverter (not shown). The motor is, for example, a three-phase alternating current motor. In this case, three wirings 2 constitute a U-phase, a V-phase and a W-phase. Alternating current signals having phases different from each other by 120° are, for example, caused to flow in the respective wirings 2 of the U-, V- and W-phases. A high voltage and a large current signal necessary for the three-phase alternating current motor flow in each wiring 2.

The electrical connection component 3 is provided with an insulating portion 8 integrally provided to the wirings 2 for insulating the wirings 2. A resin is, for example, used as a material of the insulating portion 8. The insulating portion 8 includes a wiring supporting portion 9 for supporting the wirings 2 and a flange portion 10 extending in a direction intersecting the wiring supporting portion 9. The wiring supporting portion 9 is provided on the back surface of the flange portion 10 and arranged in an opening hole 11 (see FIG. 3) of the enclosure 4 when the electrical connection component 3 is mounted on the enclosure 4. A plurality of wall portions 12 for insulating the wirings 2 adjacent to each other stand on the wiring supporting portion 9.

The electrical connection component 3 is provided with a plate portion 14 made of metal and used when the electrical connection component 3 is mounted on the enclosure 4. The plate portion 14 is integrally provided to the insulating portion 8 and fixed to the enclosure 4 as the mounting destination by fastening portions 15 (see FIG. 3 and the like). The plate portion 14 is, for example, insert-molded together with the wirings 2, thereby being integrally formed to the wirings 2 and the insulating portion 8. The plate portion 14 is, for example, formed into a substantially long plate shape having substantially tapered both ends. A metal material such as iron is, for example, used as a material of the plate portion 14. The fastening portions 15 are, for example, bolts.

As shown in FIG. 2, the electrical connection component 3 includes a sealing member 16 for sealing a gap between the electrical connection component 3 and the enclosure 4. The sealing member 16 is, for example, formed into an annular shape. The sealing member 16 is, for example, a rubber packing. An acrylic material, a silicon material or the like is, for example, used as a material of the sealing member 16. The sealing member 16 is pressed by a seal supporting portion 17 provided on the insulating portion 8 for supporting the sealing member 16. The seal supporting portion 17 is, for example, annularly formed on the back surface of the flange portion 10 to surround the wiring supporting portion 9. The seal supporting portion 17 includes a pair of positioning walls 18 on both sides of the sealing member 16.

An assembly including the wirings 2, the insulating portion 8 and the plate portion 14 is, for example, formed by insert molding. Specifically, the wirings 2 and the plate portion 14 are set in a mold, and the integrated assembly of the wirings 2, the insulating portion 8 and the plate portion 14 is manufactured by insert molding of filling a resin into the mold. In this way, the plate portion 14 is integrally formed to the insulating portion 8 by insert molding.

### (Drawing Process of Plate Portion 14)

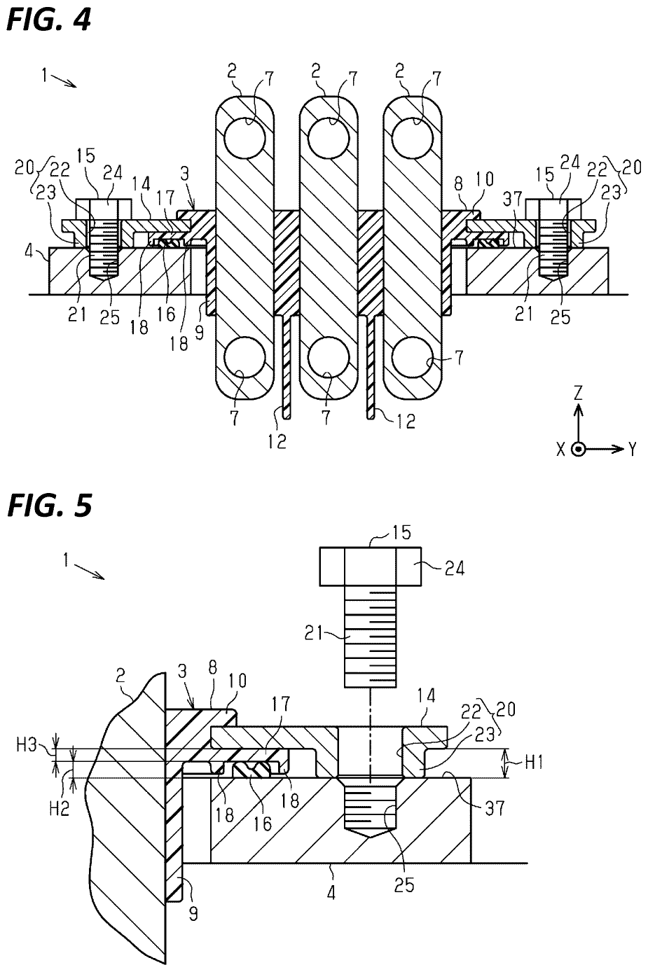

As shown in FIGS. 3 and 4, the plate portion 14 includes at least one mounting portion 20 formed by a drawing process to mount the fastening portion 15. In the case of this example, the mounting portions 20 are provided on both sides of the plate portion 14. As just described, in the case of this example, the plate portion 14 includes a total of two mounting portions 20 respectively arranged on both ends in a width direction of the plate portion 14 (Y-axis direction of FIG. 3 and the like).

The mounting portion 20 includes a hole 22, through which a shaft portion 21 of the fastening portion 15 is inserted, and a projecting wall 23 projecting toward the enclosure 4 from the peripheral edge of the hole 22. The inner peripheral surface of the hole 22 is formed into a smooth shape without any screw threads. As just described, the inner peripheral surface of the hole 22 is a flat surface without any irregularities. The fastening portion 15 fixes the plate portion 14 to the enclosure 4 by fastening the shaft portion 21 to a fastened portion 25 recessed in the enclosure 4 while bringing a head portion 24 into contact with the upper surface of the mounting portion 20.

As shown in FIG. 5, a height H1 of the projecting wall 23 is set to a value corresponding to the sealing member 16 and the seal supporting portion 17. In the case of this example, the height H1 of the projecting wall 23 is set to a value, which is the sum of a thickness H2 of the sealing member 16 resiliently deformed by the electrical connection component 3 being fixed to the enclosure 4 and a thickness H3 of the seal supporting portion 17.

### (Pattern of Drawing Process)

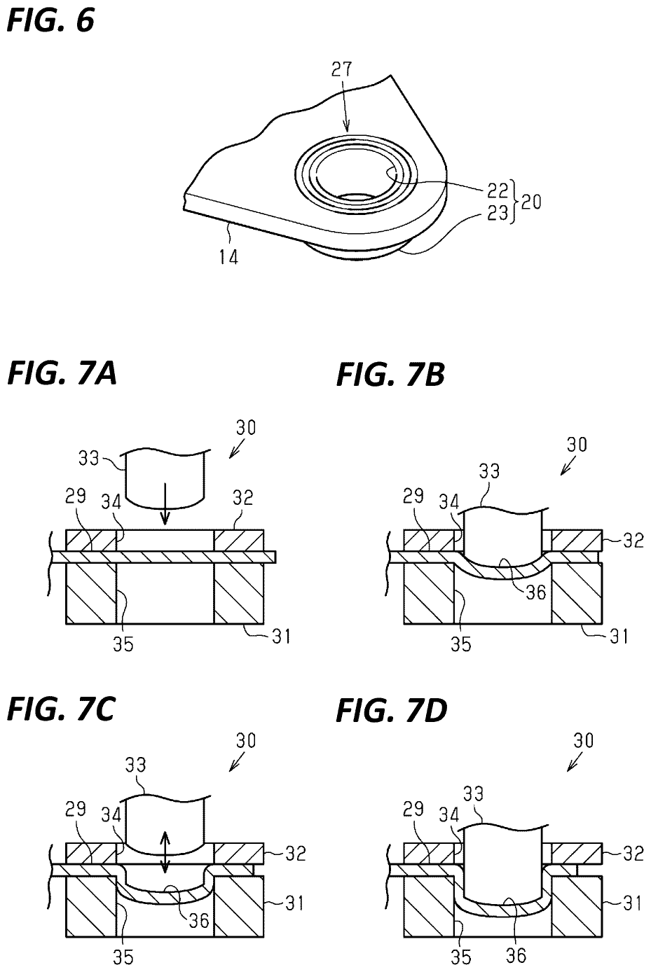

As shown in FIG. 6, the mounting portion 20 has an annular pattern 27 in a plurality of layers having different diameters around the hole 22. The annular pattern 27 is, for example, formed on the surface of the plate portion 14 in the process of forming the mounting portion 20 in the plate portion 14 by the drawing process. The annular pattern 27 is, for example, a pattern in which a plurality of circles having different diameters are concentrically arranged like annual growth rings.

Next, functions of the electrical connection component 3 (electrical connection unit 1) of this embodiment are described.

### (Procedure of Drawing Process)

As shown in FIG. 7A, a base material (hereinafter, referred to as a plate base material 29) of the plate portion 14 is first set in a drawing machine 30 to form the mounting portion 20 in the plate portion 14. Specifically, the plate base material 29 is placed on a base portion 31 of the drawing machine 30 and the upper surface of the plate base material 29 is pressed by a pressing portion 32 of the drawing machine 30. The pressing portion 32 includes an opening 34, through which a punch 33 for striking the plate base material 29 passes. The base portion 31 includes a guide recess 35 for guiding the deformation of the plate base material 29 when the plate base material 29 is struck by the punch 33.

As shown in FIG. 7B, the drawing machine 30 strikes the plate base material 29 by the punch 33. At this time, a recess 36 is formed in the plate base material 29 by a pressing force load of the punch 33. Further, if the recess 36 is formed in the plate base material 29 by the punch 33, an end part of the plate base material 29 is pulled and moved toward the recess 36. At this time, the plate base material 29 is forcibly pulled by the punch 33, whereby the annular pattern 27 is engraved over an entire circumference at the position of the plate base material 29 corresponding to a corner of the base portion 31.

Then, as shown in FIG. 7C, the punch 33 repeatedly strikes the recess 36 until the recess 36 reaches a necessary depth. At this time, a hitting force of the recess 36 and a hitting number per unit time by the punch 33 are not necessarily constant regardless of a deformation amount of the recess 36. For example, to obtain a desired depth of the recess 36, the hitting force of the recess 36 and the hitting number per unit time by the punch 33 may be changed as appropriate.

As shown in FIG. 7D, if the depth of the recess 36 reaches the necessary depth, striking by the punch 33 is finished. Then, the plate base material 29 is removed from the drawing machine 30 and the bottom wall of the recess 36 is cut by a jig (not shown) to form a hole in the recess 36. In this way, the mounting portion 20 including the hole 22 and the projecting wall 23 is formed. Similarly, a similar drawing process is applied also to the opposite side of the plate base material 29, whereby the mounting portion 20 is formed. In the above way, the mounting portions 20 are formed on both sides of the plate base material 29.

(Advantages of Plate Portion 14 Formed with Mounting Portions 20 by Drawing Process)

As shown in FIGS. 4 and 5, the sealing member 16 is pressed against the enclosure 4 with a high load by the plate portion 14 made of metal. Since the sealing member 16 is strongly pressed against the enclosure 4 by a component made of metal in this way, sufficient sealability can be satisfied. Further, this serves as a measure against a phenomenon in which deformation progresses if a fixed load continues to be applied to a resin, i.e. a so-called “creep deformation of resin”.

The plate portion 14 is shaped to be thin. Thus, a size of the electrical connection component 3 in the height direction (Z-axis direction of FIG. 4 and the like) can also be reduced, therefore contributing to the size reduction of the electrical connection component 3.

The mounting portion 20 is shaped to include the projecting wall 23 projecting in the direction toward the enclosure 4. In this way, the projecting wall 23 can be brought into contact with the enclosure 4, wherefore a surface 37 of the enclosure 4 can be shaped to be flat. Thus, it is not necessary to provide a step on the enclosure 4 and bring the step into contact with the plate portion 14. Since the enclosure 4 needs not be processed to form a step, the manufacturing of the enclosure 4 is also simplified.

The electrical connection component 3 is mounted on the enclosure 4 by fixing the plate portion 14 made of metal to the enclosure 4 by the fastening portions 15. If parts of the electrical connection component 3 where the fastening portions 15 are mounted are made of resin, separate collars are necessary to suppress resin deformation. However, in the case of this example, since the plate portion 14 made of metal is fixed by the fastening portions 15, collars are not necessary. Therefore, component cost can also be reduced.

### Effects of Embodiment

According to the configuration of the above embodiment, the following effects can be obtained.

(1) The electrical connection component 3 is provided with the wirings 2, the insulating portion 8 integrally provided to the wirings 2 and configured to insulate the wirings 2 and the plate portion 14 made of metal. The plate portion 14 is integrally provided to the insulating portion 8 and fixed to the enclosure 4 as the mounting destination by the fastening portions 15. The plate portion 14 includes at least one mounting portion 20 formed by the drawing process to mount the fastening portion 15. The mounting portion 20 includes the hole 22, through which the shaft portion 21 of the fastening portion 15 is inserted, and the projecting wall 23 projecting toward the enclosure 4 from the peripheral edge of the hole 22.

According to this configuration, the insulating portion 8 including the wirings 2 is provided with the plate portion 14 made of metal for mounting the electrical connection component 3 on the enclosure 4. The plate portion 14 is formed with the mounting portions 20 by the drawing process. The electrical connection component 3 is fixed to the enclosure 4 by mounting the fastening portions 15 into the mounting portions 20 and fastening these fastening portions 15 to the enclosure 4. Particularly, in the case of this configuration, the mounting portion 20 has a projecting shape including the projecting wall 23. Thus, the plate portion 14 is shaped to reach the surface 37 of the enclosure 4, wherefore the surface 37 of the enclosure 4 can be used in a flat state. Therefore, the surface processing of the enclosure 4 can be simplified.

(2) The mounting portions 20 are provided on the both sides of the plate portion 14. According to this configuration, the electrical connection component 3 can be firmly fixed to the enclosure 4 on the both sides of the plate portion 14.

(3) The height H1 of the projecting wall 23 is set to the value corresponding to the sealing member 16 for sealing between the enclosure 4 and the insulating portion 8 and the seal supporting portion 17 provided on the insulating portion 8 to support the sealing member 16. According to this configuration, the height H1 of the projecting wall 23 can be so set that the sealing member 16 has a sufficient sealing pressure.

(4) The inner peripheral surface of the hole 22 is formed into a smooth shape without any screw threads. According to this configuration, the shape of the mounting portion 20 can be simplified.

(5) The fastening portion 15 fixes the plate portion 14 to the enclosure 4 by fastening the shaft portion 21 to the fastened portion 25 recessed in the enclosure 4 while bringing the head portion 24 into contact with the upper surface of the mounting portion 20. According to this configuration, the plate portion 14 can be firmly fixed to the enclosure 4, using the fastening portions 15 such as bolts or screws.

(6) The plate portion 14 is integrally formed to the insulating portion 8 by insert molding. According to this configuration, the wirings 2, the insulating portion 8 and the plate portion 14 are formed as the integrated assembled, therefore contributing to ease of component handling and ease of fixing to the enclosure 4.

(7) The mounting portion 20 has the annular pattern 27 in the plurality of layers having different diameters around the hole 22. According to this configuration, whether or not the mounting portion 20 was formed by the drawing process can be immediately known.

### Other Embodiment

Note that this embodiment can be modified and carried out as follows. This embodiment and the following modifications can be combined with each other and carried out without technically contradicting.
The shape of the wiring 2 is not limited to the plate-like shape, but may be a columnar shape. Further, if the wiring 2 has a columnar shape, both ends may be formed into a plate-like shape.
The shape of the wiring 2 is not limited to a straight shape, but may be bent halfway.
The shape of the projecting wall 23 is not limited to a tubular shape, but the projecting wall 23 may be, for example, formed as a plate piece by being intermittently formed in a circumferential direction.
The arrangement positions and the number of the mounting portions 20 may be changed as appropriate.
If the plate portion 14 has a rectangular shape, the mounting portions 20 may be formed at four corners.
The inner peripheral surface of the hole 22 of the mounting portion 22 may be, for example, formed with screw threads by tapping.
The mounting portion 20 is not limitedly used as a part for fixing the electrical connection component 3 to the enclosure 4. For example, the mounting portion 20 may be used as a part for mounting another component on the electrical connection component 3.
The arrangement and the number of the mounting portions 20 can be changed as appropriate.
The drawing process technique can be changed to another technique other than the one in the embodiment as appropriate.
The fastening portion 15 is not limited to a bolt or a screw, but may be, for example, another member such as a clip.
The plate portion 14 is not limited to the one integrally formed to the insulating portion 8 by insert molding. The plate portion 14 may be retro-fit to an assembly of the wirings 2 and the insulating portion 8.
The electrical connection component 3 may not be mounted and fixed to the enclosure 4 entirely by the plate portion 14. For example, the electrical connection component 3 may be mounted and fixed to the enclosure 4 partly by the plate portion 14 and partly by the insulating portion 8.
The electrical connection component 3 is not limited to the terminal block, but may be a connector. In this case, the electrical connection unit 1 is not limited to the terminal block unit, but may be a connector unit.
In a non-limited embodiment shown in FIG. 5, the projecting wall 23 formed on the plate portion 14 by the drawing process may be referred to as a spacer projection projecting from the plate portion 14 in a direction intersecting a plane direction (XY plane) of the plate portion 14. This spacer projection may have a tubular shape and have a radially inward facing surface (e.g. the inner peripheral surface of the hole 22) continuously and seamlessly spreading from the upper surface of the plate portion 14, a radially outward facing surface (e.g. the outer peripheral surface of the projecting wall 23) continuously and seamlessly spreading from the lower surface of the plate portion 14 and a tip or an opening end surface to be directly supported on or directly held in contact with the surface 37 of the enclosure 4. This spacer projection of the plate portion 14 can include a bent portion bent, for example, at a right angle (e.g. in the Z-axis direction) to the plane direction (upper surface and lower surfaces) of the plate portion 14. This bent portion of the spacer projection can have a radially inward facing annular convex curved surface continuously and seamlessly connecting the upper surface of the plate portion 14 and the inner peripheral surface of the hole 22 or the inner peripheral surface of the projecting wall 23 and a radially outward facing annular concave curved surface continuously and seamlessly connecting the lower surface of the plate portion 14 and the outer peripheral surface of the projecting wall 23.
The plate portion 14 in the non-limited embodiment is an example of a plastic material plate. The surface 37 of the enclosure 4 may be referred to as a receiving surface or a mount surface configured to support or receive the opening end surface of the projecting wall 23.
In the non-limited embodiment shown in FIG. 5, the height H1 of the projecting wall 23 is a distance from the base end of the projecting wall 23 to the tip of the projecting wall 23 in the direction (Z-axis direction) orthogonal to the plane direction (XY plane) of the plate 14. In the example of FIG. 5, the height H1 of the projecting wall 23 is a distance from the lower surface of the plate portion 14 facing the surface 37 of the enclosure 4 to the tip of the projecting wall 23, which is possibly the opening end surface of the projecting wall 23 to be directly supported on or directly held in contact with the surface 37 of the enclosure 4.
The electrical connection component 3 and the electrical connection unit 1 of the shown non-limited embodiment may be for a vehicle such as an electric vehicle or a hybrid vehicle, similarly to those disclosed in Patent Document 1 (Japanese Unexamined Patent Publication No. 2011-177002).
The expression “at least one” used in the present disclosure means “one or more” of desired options. As an example, the expression “at least one” used in the present disclosure means “only one option” or “both of two options” if the number of options is two. As another example, the expression “at least one” used in the present disclosure means “only one option” or “a combination of two or more arbitrary options” if the number of options is three or more.
Although the present disclosure has been described with reference to the embodiment, it is understood as not being limited to the embodiment and structures. The present disclosure encompasses various modifications and modifications within the range of equivalents. In addition, various combinations and forms, as well as other combinations and forms including only one element or more or less elements than that are also within the scope and sprit of the present disclosure.

### List of Reference Numerals

1 electrical connection unit
2 wiring
3 electrical connection component
4 enclosure
7 insertion hole
8 insulating portion
9 wiring supporting portion
10 flange portion
11 opening hole
12 wall portion
14 plate portion
15 fastening portion
16 sealing member
17 seal supporting portion
18 positioning wall
20 mounting portion
21 shaft portion
22 hole
23 projecting wall
24 head portion
25 fastened portion
27 annular pattern
29 plate base material
30 drawing machine
31 base portion
32 pressing portion
33 punch
34 opening
35 guide recess
36 recess
37 surface
H1 height
H2 thickness
H3 thickness

1. An electrical connection component, comprising:
a wiring;
an insulating portion integrally provided to the wiring, the insulating portion insulating the wiring; and
a plate portion made of metal, the plate portion being integrally provided to the insulating portion, the plate portion being fixed to an enclosure as a mounting destination by a fastening portion,
the plate portion including at least one mounting portion formed by a drawing process to mount the fastening portion, and
the mounting portion including a hole, a shaft portion of the fastening portion being inserted through the hole, and a projecting wall projecting toward the enclosure from a peripheral edge of the hole.

2. The electrical connection component of claim 1, wherein the mounting portions are provided on both sides of the plate portion.

3. The electrical connection component of claim 1, wherein a height of the projecting wall is set to a value corresponding to a sealing member for sealing between the enclosure and the insulating portion and a seal supporting portion provided on the insulating portion to support the sealing member.

4. The electrical connection component of claim 1, wherein an inner peripheral surface of the hole is formed into a smooth shape without any screw threads.

5. The electrical connection component of claim 1, wherein the fastening portion fixes the plate portion to the enclosure by fastening the shaft portion to a fastened portion recessed in the enclosure while bringing a head portion into contact with an upper surface of the mounting portion.

6. The electrical connection component of claim 1, wherein the plate portion is integrally formed to the insulating portion by insert molding.

7. The electrical connection component of claim 1, wherein the mounting portion has an annular pattern in a plurality of layers having different diameters around the hole.

8. An electrical connection unit, comprising:
an electrical connection component including a wiring, an insulating portion integrally provided to the wiring, the insulating portion insulating the wiring, and a plate portion made of metal, the plate portion being integrally provided to the insulating portion; and
an enclosure, the electrical connection component being mounted on the enclosure by a fastening portion via the plate portion,
the plate portion including at least one mounting portion formed by a drawing process to mount the fastening portion, and
the mounting portion including a hole, a shaft portion of the fastening portion being inserted through the hole, and a projecting wall projecting toward the enclosure from a peripheral edge of the hole.
